(19) United States
(12) Patent Application Publication
(10) Pub. No.: US 2025/0126590 A1
(43) Pub. Date: Apr. 17, 2025

(54) APPARATUS, METHODS, FOR APPARATUS AND COMPUTER PROGRAM PRODUCTS FOR LOCATION FUNCTION INCLUDING NON-TERESTRIAL ACCESS POINT

(71) Applicant: Nokia Technologies Oy, Espoo (FI)

(72) Inventors: Benny VEJLGAARD, Aalborg (DK); Oana-Elena BARBU, Aalborg (DK); Ryan KEATING, Naperville, IL (US); Johannes HARREBEK, Aalborg (DK); Jeroen WIGARD, Aalborg (DK)

(21) Appl. No.: 18/293,897

(22) PCT Filed: Aug. 11, 2021
(86) PCT No.: PCT/EP2021/072423

§ 371 Date: Jan. 31, 2024

(51) Int. Cl. H04W 64/00; H04W 74/0816; H04W 84/06

(52) U.S. Cl. CPC H04W 64/00; H04W 74/0816; H04W 84/06

(57) ABSTRACT

There is provided an apparatus that is caused to: in response to determining that a plurality of access points to be configured to provide positioning reference signals to a user equipment comprises at least one non-terrestrial access point and at least one terrestrial access point: determining, for the at least one non-terrestrial access point, a propagation delay for signalling between said non-terrestrial access point and the user equipment; using the determined propagation delay to select a configuration of at least one of: a duration of a measurement gap at the user equipment in which the user equipment is to perform positioning-related measurements on positioning reference signals transmitted by the plurality of access points, and a transmission time of at least one positioning reference signal to be provided to the user equipment by at least one of the plurality of access points; and signalling the selected configuration.

### FIELD

The present disclosure relates to apparatus, methods, and computer programs, and in particular but not exclusively to apparatus, methods and computer programs for network apparatuses.

### BACKGROUND

A communication system can be seen as a facility that enables communication sessions between two or more entities such as user terminals, access nodes and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Content may be multicast or uni-cast to communication devices.

A user can access the communication system by means of an appropriate communication device or terminal. A communication device of a user is often referred to as user equipment (UE) or user device. The communication device may access a carrier provided by an access node and transmit and/or receive communications on the carrier.

The communication system and associated devices typically operate in accordance with a required standard or specification which sets out what the various entities associated with the system are permitted to do and how that should be achieved. Communication protocols and/or parameters which shall be used for the connection are also typically defined. One example of a communications system is UTRAN (3G radio). Another example of an architecture that is known is the long-term evolution (LTE) or the Universal Mobile Telecommunications System (UMTS) radio-access technology. Another example communication system is so called 5G system that allows user equipment (UE) or user device to contact a 5G core via e.g. New radio (NR) access technology or via other access technology such as Untrusted access to 5GC or wireline access technology.

### SUMMARY

According to a first aspect, there is provided an apparatus for a location function, the apparatus comprising means for: in response to determining that a plurality of access points to be configured to provide positioning signals to a user equipment comprises at least one non-terrestrial access point: determining, for the at least one non-terrestrial access point, a propagation delay for signalling between said non-terrestrial access point and the user equipment; using the determined propagation delay to select a configuration of at least one of: a duration of a measurement gap at the user equipment in which the user equipment is to perform positioning-related measurements on positioning signals transmitted by the plurality of access points, and a transmission time of at least one positioning signal to be provided to the user equipment by at least one of the plurality of access points; and signalling the selected configuration.

When a duration of the measurement gap is selected, said means for signalling the selected configuration may comprise means for signalling the selected configuration to the user equipment either directly or indirectly.

The means for using the determined propagation delay to select a configuration may comprise means for: comparing the propagation delay for signalling between said non-terrestrial access point and the user equipment to a propagation delay for signalling between the user equipment and a serving access point serving the user equipment; calculating a duration of a measurement gap that would, if respective positioning signals are transmitted from the serving access point and the non-terrestrial access point at the same time, cause the respective positioning signals to be received by the user equipment within the measurement gap; and comprising an indication of the calculated duration within the selected configuration.

When a transmission time is selected, said means for signalling the selected configuration may comprise means for signalling the selected configuration to the at least one access point providing the at least one positioning signal either directly or indirectly.

The means for using the determined propagation delay to select a configuration may comprise means for: comparing the propagation delay for signalling between said non-terrestrial access point and the user equipment to a propagation delay for signalling between the user equipment and a serving access point serving the user equipment; calculating a time offset between respective transmissions of positioning signals to be transmitted from the serving access point and the non-terrestrial access point such that the respective transmissions are estimated to arrive at the user equipment within a predetermined measurement gap; and comprising an indication of the time offset within the selected configuration.

The transmission time may indicate a time for at least one terrestrial access point in the plurality of access points to transmit its positioning signal, said time being later than a time at which a non-terrestrial access point in the plurality of access points is scheduled to transmit its positioning signal.

The apparatus may comprise means for: receiving, from an access point of the plurality of access points, an indication that measurement data obtained by the user equipment does not comprise measurement data associated with any non-terrestrial access point; selecting a new configuration by selecting at least one of: a new duration of a new measurement gap at the user equipment in which the user equipment is to perform positioning-related measurements on positioning signals transmitted by the plurality of access points, and a new transmission time of at least one positioning signal to be provided to the user equipment by at least one of the plurality of access points; and signalling the selected new configuration.

The new configuration may be selected such that the new transmission timing and/or the new duration is determined on at least one of a satellite ephemeris of said non-terrestrial access point, a height above ground of said non-terrestrial access point, a feeder link delay of said non-terrestrial access point, and a user equipment location determined based on the access points that the user equipment provided measurement information on.

The propagation delay may be represented by a round trip time, and/or wherein the propagation delay is determined in dependence on at least one of a height above ground of said non-terrestrial access points and/or feeder links of said non-terrestrial access points.

Said means for determining the propagation delay may comprise means for signalling at least one of the non-terrestrial access points for an indication of the propagation delay, and receiving said indication of the propagation delay from the at least one non-terrestrial access point.

The determining the propagation delay for signalling between said non-terrestrial access point and the user equipment may be performed in response to both determining that a plurality of access points to be configured to provide positioning signals to a user equipment comprises at least one non-terrestrial access point and at least one terrestrial access point.

According to a second aspect, there is provided an apparatus for a user equipment, the apparatus comprising means for: receiving, from a serving access point, an indication that measurements on first positioning signals from a plurality of access points are to be performed within a first measurement gap having a first value; configuring the first measurement gap, wherein the measurement gap is configurable to take at least the first value and a second value; determining first positioning information for the user equipment using measurements made on said first positioning during the configured first measurement gap; and signalling the first positioning information to the serving access point.

The apparatus may comprise means for: receiving, from the serving access point, an indication that measurements on second positioning signals from the plurality of access points are to be performed within a second measurement gap having the second value; configuring the second measurement gap to have the second value; determining second positioning information for the user equipment using measurements made on said second positioning signals during the configured second measurement gap; and signalling the second positioning information to the serving access point.

According to a third aspect, there is provided an apparatus for an access point configured to serve a user equipment, the apparatus comprising means for: receiving, from a location function, a configuration of at least one of: a duration of a measurement gap at the user equipment in which the user equipment is to perform positioning-related measurements on positioning signals transmitted by the plurality of access points, and a transmission time of at least one positioning signal to be provided to the user equipment by at least one of the plurality of access points; and when the duration is indicated in the configuration, signalling the duration to the user equipment; and when the transmission time is indicated in the configuration, signalling a positioning signal to the user equipment at the transmission time.

The apparatus may comprise means for: receiving, from the location function, a new configuration of at least one of: a new duration of a measurement gap at the user equipment in which the user equipment is to perform positioning-related measurements on positioning signals transmitted by the plurality of access points, and a new transmission time of at least one positioning signal to be provided to the user equipment by at least one of the plurality of access points; and when the new duration is indicated in the configuration, signalling the new duration to the user equipment; and when the new transmission time is indicated in the configuration, signalling a positioning signal to the user equipment at the new transmission time.

According to a fourth aspect, there is provided an apparatus for a non-terrestrial access point, the apparatus comprising means for: receiving, from a location function, a request for an indication of a propagation delay for signalling between said non-terrestrial access point and a user equipment; and providing, to the location function, the requested indication.

The propagation delay may be represented by a round trip time, and/or wherein the propagation delay may be determined in dependence on at least one of a height above ground of said non-terrestrial access point and/or feeder links of said non-terrestrial access point.

According to a fifth aspect, there is provided an apparatus for a location function, the apparatus comprising: at least one processor; and at least one memory comprising code that, when executed by the at least one processor, causes the apparatus to: in response to determining that a plurality of access points to be configured to provide positioning signals to a user equipment comprises at least one non-terrestrial access point: determine, for the at least one non-terrestrial access point, a propagation delay for signalling between said non-terrestrial access point and the user equipment; use the determined propagation delay to select a configuration of at least one of: a duration of a measurement gap at the user equipment in which the user equipment is to perform positioning-related measurements on positioning signals transmitted by the plurality of access points, and a transmission time of at least one positioning signal to be provided to the user equipment by at least one of the plurality of access points; and signal the selected configuration.

When a duration of the measurement gap is selected, said signal the selected configuration may comprise signalling the selected configuration to the user equipment either directly or indirectly.

The use the determined propagation delay to select a configuration may comprise performing: comparing the propagation delay for signalling between said non-terrestrial access point and the user equipment to a propagation delay for signalling between the user equipment and a serving access point serving the user equipment; calculating a duration of a measurement gap that would, if respective positioning signals are transmitted from the serving access point and the non-terrestrial access point at the same time, cause the respective positioning signals to be received by the user equipment within the measurement gap; and comprising an indication of the calculated duration within the selected configuration.

When a transmission time is selected, said signal the selected configuration may comprise signalling the selected configuration to the at least one access point providing the at least one positioning signal either directly or indirectly.

The use the determined propagation delay to select a configuration may comprise performing: comparing the propagation delay for signalling between said non-terrestrial access point and the user equipment to a propagation delay for signalling between the user equipment and a serving access point serving the user equipment; calculating a time offset between respective transmissions of positioning signals to be transmitted from the serving access point and the non-terrestrial access point such that the respective transmissions are estimated to arrive at the user equipment within a predetermined measurement gap; and comprising an indication of the time offset within the selected configuration.

The transmission time may indicate a time for at least one terrestrial access point in the plurality of access points to transmit its positioning signal, said time being later than a time at which a non-terrestrial access point in the plurality of access points is scheduled to transmit its positioning signal.

The apparatus may be caused to: receive, from an access point of the plurality of access points, an indication that measurement data obtained by the user equipment does not comprise measurement data associated with any non-terrestrial access point; select a new configuration by selecting at least one of: a new duration of a new measurement gap at the user equipment in which the user equipment is to perform positioning-related measurements on positioning signals transmitted by the plurality of access points, and a new transmission time of at least one positioning signal to be provided to the user equipment by at least one of the plurality of access points; and signal the selected new configuration.

The new configuration may be selected such that the new transmission timing and/or the new duration is determined on at least one of: a satellite ephemeris of said non-terrestrial access point, a height above ground of said non-terrestrial access point, a feeder link delay of said non-terrestrial access point, and a user equipment location determined based on the access points that the user equipment provided measurement information on.

The propagation delay may be represented by a round trip time, and/or wherein the propagation delay is determined in dependence on at least one of a height above ground of said non-terrestrial access points and/or feeder links of said non-terrestrial access points.

Said determine the propagation delay may comprise signalling at least one of the non-terrestrial access points for an indication of the propagation delay, and receiving said indication of the propagation delay from the at least one non-terrestrial access point.

The determine the propagation delay for signalling between said non-terrestrial access point and the user equipment may be performed in response to both determining that a plurality of access points to be configured to provide positioning signals to a user equipment comprises at least one non-terrestrial access point and at least one terrestrial access point.

According to a sixth aspect, there is provided an apparatus for a user equipment, the apparatus comprising: at least one processor; and at least one memory comprising code that, when executed by the at least one processor, causes the at least one processor to: receive, from a serving access point, an indication that measurements on first positioning signals from a plurality of access points are to be performed within a first measurement gap having a first value; configure the first measurement gap, wherein the measurement gap is configurable to take at least the first value and a second value; determine first positioning information for the user equipment using measurements made on said first positioning during the configured first measurement gap; and signal the first positioning information to the serving access point.

The apparatus may be caused to: receive, from the serving access point, an indication that measurements on second positioning signals from the plurality of access points are to be performed within a second measurement gap having the second value; configure the second measurement gap to have the second value; determining second positioning information for the user equipment using measurements made on said second positioning signals during the configured second measurement gap; and signal the second positioning information to the serving access point.

According to a seventh aspect, there is provided an apparatus for an access point configured to serve a user equipment, the apparatus comprising: at least one processor; and at least one memory comprising code that, when executed by the at least one processor, causes the apparatus to: receive, from a location function, a configuration of at least one of: a duration of a measurement gap at the user equipment in which the user equipment is to perform positioning-related measurements on positioning signals transmitted by the plurality of access points, and a transmission time of at least one positioning signal to be provided to the user equipment by at least one of the plurality of access points; and when the duration is indicated in the configuration, signal the duration to the user equipment; and when the transmission time is indicated in the configuration, signal a positioning signal to the user equipment at the transmission time.

The apparatus may be caused to: receive, from the location function, a new configuration of at least one of: a new duration of a measurement gap at the user equipment in which the user equipment is to perform positioning-related measurements on positioning signals transmitted by the plurality of access points, and a new transmission time of at least one positioning signal to be provided to the user equipment by at least one of the plurality of access points; and when the new duration is indicated in the configuration, signal the new duration to the user equipment; and when the new transmission time is indicated in the configuration, signal a positioning signal to the user equipment at the new transmission time.

According to an eighth aspect, there is provided an apparatus for a non-terrestrial access point, the apparatus comprising: at least one processor; and at least one memory comprising code that, when executed by the at least one apparatus, causes the apparatus to: receive, from a location function, a request for an indication of a propagation delay for signalling between said non-terrestrial access point and a user equipment; and provide, to the location function, the requested indication.

The propagation delay may be represented by a round trip time, and/or wherein the propagation delay may be determined in dependence on at least one of a height above ground of said non-terrestrial access point and/or feeder links of said non-terrestrial access point.

According to a ninth aspect, there is provided a method for an apparatus for a location function, the method comprising: in response to determining that a plurality of access points to be configured to provide positioning signals to a user equipment comprises at least one non-terrestrial access point: determining, for the at least one non-terrestrial access point, a propagation delay for signalling between said non-terrestrial access point and the user equipment; using the determined propagation delay to select a configuration of at least one of: a duration of a measurement gap at the user equipment in which the user equipment is to perform positioning-related measurements on positioning signals transmitted by the plurality of access points, and a transmission time of at least one positioning signal to be provided to the user equipment by at least one of the plurality of access points; and signalling the selected configuration.

When a duration of the measurement gap is selected, said signalling the selected configuration may comprise signalling the selected configuration to the user equipment either directly or indirectly.

The using the determined propagation delay to select a configuration may comprise: comparing the propagation delay for signalling between said non-terrestrial access point and the user equipment to a propagation delay for signalling between the user equipment and a serving access point serving the user equipment; calculating a duration of a measurement gap that would, if respective positioning signals are transmitted from the serving access point and the non-terrestrial access point at the same time, cause the respective positioning signals to be received by the user equipment within the measurement gap; and comprising an indication of the calculated duration within the selected configuration.

When a transmission time is selected, said signalling the selected configuration may comprise signalling the selected configuration to the at least one access point providing the at least one positioning signal either directly or indirectly.

The using the determined propagation delay to select a configuration may comprise: comparing the propagation delay for signalling between said non-terrestrial access point and the user equipment to a propagation delay for signalling between the user equipment and a serving access point serving the user equipment; calculating a time offset between respective transmissions of positioning signals to be transmitted from the serving access point and the non-terrestrial access point such that the respective transmissions are estimated to arrive at the user equipment within a predetermined measurement gap; and comprising an indication of the time offset within the selected configuration.

The transmission time may indicate a time for at least one terrestrial access point in the plurality of access points to transmit its positioning signal, said time being later than a time at which a non-terrestrial access point in the plurality of access points is scheduled to transmit its positioning signal.

The method may comprise: receiving, from an access point of the plurality of access points, an indication that measurement data obtained by the user equipment does not comprise measurement data associated with any non-terrestrial access point; selecting a new configuration by selecting at least one of: a new duration of a new measurement gap at the user equipment in which the user equipment is to perform positioning-related measurements on positioning signals transmitted by the plurality of access points, and a new transmission time of at least one positioning signal to be provided to the user equipment by at least one of the plurality of access points; and signalling the selected new configuration.

The new configuration may be selected such that the new transmission timing and/or the new duration is determined on at least one of a satellite ephemeris of said non-terrestrial access point, a height above ground of said non-terrestrial access point, a feeder link delay of said non-terrestrial access point, and a user equipment location determined based on the access points that the user equipment provided measurement information on.

The propagation delay may be represented by a round trip time, and/or wherein the propagation delay is determined in dependence on at least one of a height above ground of said non-terrestrial access points and/or feeder links of said non-terrestrial access points.

Said determining the propagation delay may comprise signalling at least one of the non-terrestrial access points for an indication of the propagation delay, and receiving said indication of the propagation delay from the at least one non-terrestrial access point.

The determining the propagation delay for signalling between said non-terrestrial access point and the user equipment may be performed in response to both determining that a plurality of access points to be configured to provide positioning signals to a user equipment comprises at least one non-terrestrial access point and at least one terrestrial access point.

According to a tenth aspect, there is provided a method for an apparatus for a user equipment, the method comprising: receiving, from a serving access point, an indication that measurements on first positioning signals from a plurality of access points are to be performed within a first measurement gap having a first value; configuring the first measurement gap, wherein the measurement gap is configurable to take at least the first value and a second value; determining first positioning information for the user equipment using measurements made on said first positioning during the configured first measurement gap; and signalling the first positioning information to the serving access point.

The method may comprise: receiving, from the serving access point, an indication that measurements on second positioning signals from the plurality of access points are to be performed within a second measurement gap having the second value; configuring the second measurement gap to have the second value; determining second positioning information for the user equipment using measurements made on said second positioning signals during the configured second measurement gap; and signalling the second positioning information to the serving access point.

According to an eleventh aspect, there is provided a method for an apparatus for an access point configured to serve a user equipment, the method comprising: receiving, from a location function, a configuration of at least one of: a duration of a measurement gap at the user equipment in which the user equipment is to perform positioning-related measurements on positioning signals transmitted by the plurality of access points, and a transmission time of at least one positioning signal to be provided to the user equipment by at least one of the plurality of access points; and when the duration is indicated in the configuration, signalling the duration to the user equipment; and when the transmission time is indicated in the configuration, signalling a positioning signal to the user equipment at the transmission time.

The method may comprise: receiving, from the location function, a new configuration of at least one of: a new duration of a measurement gap at the user equipment in which the user equipment is to perform positioning-related measurements on positioning signals transmitted by the plurality of access points, and a new transmission time of at least one positioning signal to be provided to the user equipment by at least one of the plurality of access points; and when the new duration is indicated in the configuration, signalling the new duration to the user equipment; and when the new transmission time is indicated in the configuration, signalling a positioning signal to the user equipment at the new transmission time.

According to a twelfth aspect, there is provided a method for an apparatus for a non-terrestrial access point, the method comprising: receiving, from a location function, a request for an indication of a propagation delay for signalling between said non-terrestrial access point and a user equipment; and providing, to the location function, the requested indication.

The propagation delay may be represented by a round trip time, and/or wherein the propagation delay may be determined in dependence on at least one of a height above ground of said non-terrestrial access point and/or feeder links of said non-terrestrial access point.

According to a thirteenth aspect, there is provided an apparatus for a location function, the apparatus comprising: circuitry for, in response to determining that a plurality of access points to be configured to provide positioning signals to a user equipment comprises at least one non-terrestrial access point: determining circuitry for determining, for the at least one non-terrestrial access point, a propagation de-lay for signalling between said non-terrestrial access point and the user equipment; using circuitry for using the determined propagation delay to select a configuration of at least one of: a duration of a measurement gap at the user equipment in which the user equipment is to perform positioning-related measurements on positioning signals transmitted by the plurality of access points, and a transmission time of at least one positioning signal to be provided to the user equipment by at least one of the plurality of access points; and signalling circuitry for signalling the selected configuration.

When a duration of the measurement gap is selected, said signalling circuitry for signalling the selected configuration may comprise signalling circuitry for signalling the selected configuration to the user equipment either directly or indirectly.

The using circuitry for using the determined propagation delay to select a configuration may comprise: comparing circuitry for comparing the propagation delay for signalling between said non-terrestrial access point and the user equipment to a propagation delay for signalling between the user equipment and a serving access point serving the user equipment; calculating circuitry for calculating a duration of a measurement gap that would, if respective positioning signals are transmitted from the serving access point and the non-terrestrial access point at the same time, cause the respective positioning signals to be received by the user equipment within the measurement gap; and comprising circuitry for comprising an indication of the calculated duration within the selected configuration.

When a transmission time is selected, said signalling circuitry for signalling the selected configuration may comprise signalling circuitry for signalling the selected configuration to the at least one access point providing the at least one positioning signal either directly or indirectly.

The using circuitry for using the determined propagation delay to select a configuration may comprise: comparing circuitry for comparing the propagation delay for signalling between said non-terrestrial access point and the user equipment to a propagation delay for signalling between the user equipment and a serving access point serving the user equipment; calculating circuitry for calculating a time offset between respective transmissions of positioning signals to be transmitted from the serving access point and the non-terrestrial access point such that the respective transmissions are estimated to arrive at the user equipment within a predetermined measurement gap; and comprising circuitry for comprising an indication of the time offset within the selected configuration.

The transmission time may indicate a time for at least one terrestrial access point in the plurality of access points to transmit its positioning signal, said time being later than a time at which a non-terrestrial access point in the plurality of access points is scheduled to transmit its positioning signal.

The apparatus may comprise: receiving circuitry for receiving, from an access point of the plurality of access points, an indication that measurement data obtained by the user equipment does not comprise measurement data associated with any non-terrestrial access point; selecting circuitry for selecting a new configuration by selecting at least one of: a new duration of a new measurement gap at the user equipment in which the user equipment is to perform positioning-related measurements on positioning signals transmitted by the plurality of access points, and a new transmission time of at least one positioning signal to be provided to the user equipment by at least one of the plurality of access points; and signalling circuitry for signalling the selected new configuration.

The new configuration may be selected such that the new transmission timing and/or the new duration is determined on at least one of a satellite ephemeris of said non-terrestrial access point, a height above ground of said non-terrestrial access point, a feeder link delay of said non-terrestrial access point, and a user equipment location determined based on the access points that the user equipment provided measurement information on.

The propagation delay may be represented by a round trip time, and/or wherein the propagation delay is determined in dependence on at least one of a height above ground of said non-terrestrial access points and/or feeder links of said non-terrestrial access points.

Said determining circuitry for determining the propagation delay may comprise signalling circuitry for signalling at least one of the non-terrestrial access points for an indication of the propagation delay, and receiving circuitry for receiving said indication of the propagation delay from the at least one non-terrestrial access point.

The determining the propagation delay for signalling between said non-terrestrial access point and the user equipment may be performed in response to both determining that a plurality of access points to be configured to provide positioning signals to a user equipment comprises at least one non-terrestrial access point and at least one terrestrial access point.

According to a fourteenth aspect, there is provided an apparatus for a user equipment, the apparatus comprising: receiving circuitry for receiving, from a serving access point, an indication that measurements on first positioning signals from a plurality of access points are to be performed within a first measurement gap having a first value; configuring circuitry for configuring the first measurement gap, wherein the measurement gap is configurable to take at least the first value and a second value; determining circuitry for determining first positioning information for the user equipment using measurements made on said first positioning during the configured first measurement gap; and signalling circuitry for signalling the first positioning information to the serving access point.

The apparatus may comprise: receiving circuitry for receiving, from the serving access point, an indication that measurements on second positioning signals from the plurality of access points are to be performed within a second measurement gap having the second value; configuring circuitry for configuring the second measurement gap to have the second value; determining circuitry for determining second positioning information for the user equipment using measurements made on said second positioning signals during the configured second measurement gap; and signalling circuitry for signalling the second positioning information to the serving access point.

According to a fifteenth aspect, there is provided an apparatus for an access point configured to serve a user equipment, the apparatus comprising: receiving circuitry for receiving, from a location function, a configuration of at least one of: a duration of a measurement gap at the user equipment in which the user equipment is to perform positioning-related measurements on positioning signals transmitted by the plurality of access points, and a transmission time of at least one positioning signal to be provided to the user equipment by at least one of the plurality of access points; and signalling circuitry for, when the duration is indicated in the configuration, signalling the duration to the user equipment; and signalling circuitry for when the transmission time is indicated in the configuration, signalling a positioning signal to the user equipment at the transmission time.

The apparatus may comprise: receiving circuitry for receiving, from the location function, a new configuration of at least one of: a new duration of a measurement gap at the user equipment in which the user equipment is to perform positioning-related measurements on positioning signals transmitted by the plurality of access points, and a new transmission time of at least one positioning signal to be provided to the user equipment by at least one of the plurality of access points; and signalling circuitry for, when the new duration is indicated in the configuration, signalling the new duration to the user equipment; and, signalling circuitry for, when the new transmission time is indicated in the configuration, signalling a positioning signal to the user equipment at the new transmission time.

According to a sixteenth aspect, there is provided an apparatus for a non-terrestrial access point, the apparatus comprising: receiving circuitry for receiving, from a location function, a request for an indication of a propagation delay for signalling between said non-terrestrial access point and a user equipment; and providing circuitry for providing, to the location function, the requested indication.

The propagation delay may be represented by a round trip time, and/or wherein the propagation delay may be determined in dependence on at least one of a height above ground of said non-terrestrial access point and/or feeder links of said non-terrestrial access point.

According to a seventeenth aspect, there is provided non-transitory computer readable medium comprising program instructions for causing an apparatus for a location function to perform at least the following: in response to determining that a plurality of access points to be configured to provide positioning signals to a user equipment comprises at least one non-terrestrial access point: determine, for the at least one non-terrestrial access point, a propagation delay for signalling between said non-terrestrial access point and the user equipment; use the determined propagation delay to select a configuration of at least one of: a duration of a measurement gap at the user equipment in which the user equipment is to perform positioning-related measurements on positioning signals transmitted by the plurality of access points, and a transmission time of at least one positioning signal to be provided to the user equipment by at least one of the plurality of access points; and signal the selected configuration.

When a duration of the measurement gap is selected, said signal the selected configuration may comprise signalling the selected configuration to the user equipment either directly or indirectly.

The use the determined propagation delay to select a configuration may comprise performing: comparing the propagation delay for signalling between said non-terrestrial access point and the user equipment to a propagation delay for signalling between the user equipment and a serving access point serving the user equipment; calculating a duration of a measurement gap that would, if respective positioning signals are transmitted from the serving access point and the non-terrestrial access point at the same time, cause the respective positioning signals to be received by the user equipment within the measurement gap; and comprising an indication of the calculated duration within the selected configuration.

When a transmission time is selected, said signal the selected configuration may comprise signalling the selected configuration to the at least one access point providing the at least one positioning signal either directly or indirectly.

The use the determined propagation delay to select a configuration may comprise performing: comparing the propagation delay for signalling between said non-terrestrial access point and the user equipment to a propagation delay for signalling between the user equipment and a serving access point serving the user equipment; calculating a time offset between respective transmissions of positioning signals to be transmitted from the serving access point and the non-terrestrial access point such that the respective transmissions are estimated to arrive at the user equipment within a predetermined measurement gap; and comprising an indication of the time offset within the selected configuration.

The transmission time may indicate a time for at least one terrestrial access point in the plurality of access points to transmit its positioning signal, said time being later than a time at which a non-terrestrial access point in the plurality of access points is scheduled to transmit its positioning signal.

The apparatus may be caused to: receive, from an access point of the plurality of access points, an indication that measurement data obtained by the user equipment does not comprise measurement data associated with any non-terrestrial access point; select a new configuration by selecting at least one of: a new duration of a new measurement gap at the user equipment in which the user equipment is to perform positioning-related measurements on positioning signals transmitted by the plurality of access points, and a new transmission time of at least one positioning signal to be provided to the user equipment by at least one of the plurality of access points; and signal the selected new configuration.

The new configuration may be selected such that the new transmission timing and/or the new duration is determined on at least one of: a satellite ephemeris of said non-terrestrial access point, a height above ground of said non-terrestrial access point, a feeder link delay of said non-terrestrial access point, and a user equipment location determined based on the access points that the user equipment provided measurement information on.

The propagation delay may be represented by a round trip time, and/or wherein the propagation delay is determined in dependence on at least one of a height above ground of said non-terrestrial access points and/or feeder links of said non-terrestrial access points.

Said determine the propagation delay may comprise signalling at least one of the non-terrestrial access points for an indication of the propagation delay, and receiving said indication of the propagation delay from the at least one non-terrestrial access point.

The determine the propagation delay for signalling between said non-terrestrial access point and the user equipment may be performed in response to both determining that a plurality of access points to be configured to provide positioning signals to a user equipment comprises at least one non-terrestrial access point and at least one terrestrial access point.

According to an eighteenth aspect, there is provided non-transitory computer readable medium comprising program instructions for causing an apparatus for a user equipment to perform at least the following: receive, from a serving access point, an indication that measurements on first positioning signals from a plurality of access points are to be performed within a first measurement gap having a first value; configure the first measurement gap, wherein the measurement gap is configurable to take at least the first value and a second value; determine first positioning information for the user equipment using measurements made on said first positioning during the configured first measurement gap; and signal the first positioning information to the serving access point.

The apparatus may be caused to: receive, from the serving access point, an indication that measurements on second positioning signals from the plurality of access points are to be performed within a second measurement gap having the second value; configure the second measurement gap to have the second value; determining second positioning information for the user equipment using measurements made on said second positioning signals during the configured second measurement gap; and signal the second positioning information to the serving access point.

According to a nineteenth aspect, there is provided non-transitory computer readable medium comprising program instructions for causing an apparatus for an access point configured to serve a user equipment to perform at least the following: receive, from a location function, a configuration of at least one of: a duration of a measurement gap at the user equipment in which the user equipment is to perform positioning-related measurements on positioning signals transmitted by the plurality of access points, and a transmission time of at least one positioning signal to be provided to the user equipment by at least one of the plurality of access points; and when the duration is indicated in the configuration, signal the duration to the user equipment; and when the transmission time is indicated in the configuration, signal a positioning signal to the user equipment at the transmission time.

The apparatus may be caused to: receive, from the location function, a new configuration of at least one of: a new duration of a measurement gap at the user equipment in which the user equipment is to perform positioning-related measurements on positioning signals transmitted by the plurality of access points, and a new transmission time of at least one positioning signal to be provided to the user equipment by at least one of the plurality of access points; and when the new duration is indicated in the configuration, signal the new duration to the user equipment; and when the new transmission time is indicated in the configuration, signal a positioning signal to the user equipment at the new transmission time.

According to a twentieth aspect, there is provided non-transitory computer readable medium comprising program instructions for causing an apparatus for a non-terrestrial access point to perform at least the following: receive, from a location function, a request for an indication of a propagation delay for signalling between said non-terrestrial access point and a user equipment; and provide, to the location function, the requested indication.

The propagation delay may be represented by a round trip time, and/or wherein the propagation delay may be determined in dependence on at least one of a height above ground of said non-terrestrial access point and/or feeder links of said non-terrestrial access point.

According to a twenty first aspect, there is provided a computer program comprising program instructions for causing a computer to perform any method as described above.

According to a twenty second aspect, there is provided a computer program product stored on a medium that may cause an apparatus to perform any method as described herein.

According to a twenty third aspect, there is provided an electronic device that may comprise apparatus as described herein.

According to a twenty fourth aspect, there is provided a chipset that may comprise an apparatus as described herein.

### BRIEF DESCRIPTION OF FIGURES

Examples will now be described, by way of example only, with reference to the accompanying Figures in which:

FIG. 1 shows a schematic representation of a 5G system;

FIG. 2 shows a schematic representation of a network apparatus;

FIG. 3 shows a schematic representation of a user equipment;

FIG. 4 shows a schematic representation of a non-volatile memory medium storing instructions which when executed by a processor allow a processor to perform one or more of the steps of the methods of some examples;

FIG. 5 shows a schematic representation of an example network;

FIG. 6 shows a schematic representation of different types of access points providing positioning signals;

FIG. 7 shows a schematic representation of an example signalling;

FIG. 8 is an example signalling diagram;

FIG. 9 shows a schematic representation of an example signalling;

FIG. 10 is an example signalling diagram; and

FIGS. 11 to 14 are example flow charts illustrating operations that may be performed by example elements.

### DETAILED DESCRIPTION

In the following, certain aspects are explained with reference to mobile communication devices capable of communication via a wireless cellular system and mobile communication systems serving such mobile communication devices. For brevity and clarity, the following describes such aspects with reference to a 5G wireless communication system. However, it is understood that such aspects are not limited to 5G wireless communication systems, and may, for example, be applied to other wireless communication systems with analogous components (for example, current 6G proposals).

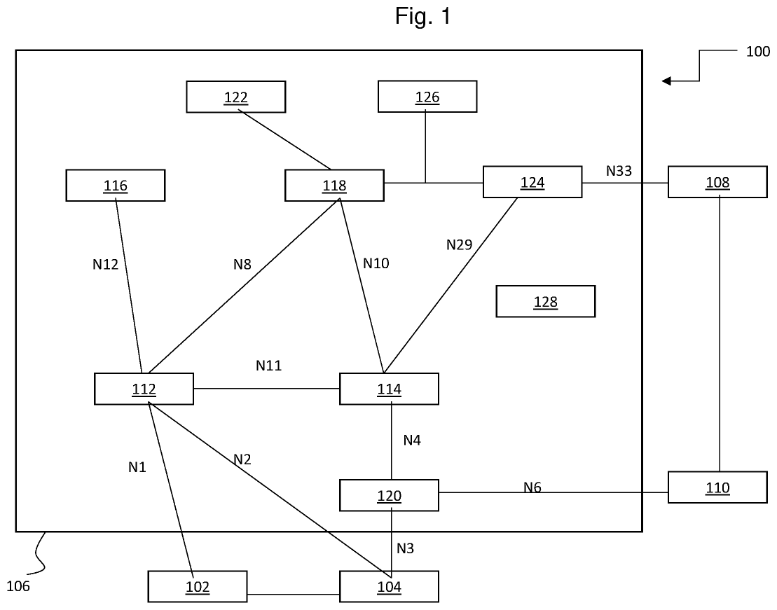

Before explaining in detail the exemplifying embodiments, certain general principles of a 5G wireless communication system are briefly explained with reference to FIG. 1.

FIG. 1 shows a schematic representation of a 5G system (5GS) 100. The 5GS may comprise a user equipment (UE) 102 (which may also be referred to as a communication device or a terminal), a 5G access network (AN) (which may be a 5G Radio Access network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

The 5G RAN may comprise one or more gNodeB (gNB) distributed unit functions connected to one or more gNodeB (gNB) unit functions. The RAN may comprise one or more access nodes.

The 5GC 106 may comprise one or more Access Management Functions (AMF) 112, one or more Session Management Functions (SMF) 114, one or more authentication server functions (AUSF) 116, one or more unified data management (UDM) functions 118, one or more user plane functions (UPF) 120, one or more unified data repository (UDR) functions 122, one or more network repository functions (NRF) 128, and/or one or more network exposure functions (NEF) 124. Although NRF 128 is not depicted with its interfaces, it is understood that this is for clarity reasons and that NRF 128 may have a plurality of interfaces with other network functions.

The 5GC 106 also comprises a network data analytics function (NWDAF) 126. The NWDAF is responsible for providing network analytics information upon request from one or more network functions or apparatus within the network. Network functions can also subscribe to the NWDAF 126 to receive information therefrom. Accordingly, the NWDAF 126 is also configured to receive and store network information from one or more network functions or apparatus within the network. The data collection by the NWDAF 126 may be performed based on at least one subscription to the events provided by the at least one network function.

3GPP refers to a group of organizations that develop and release different standardized communication protocols. 3GPP is currently developing and publishing documents related to Release 16, relating to 5G technology, with Release 17 currently being scheduled for 2022.

A Release 16 work item was conducted in 3GPP for determining how to provide support in New Radio (NR) for determining the location of a UE. As the result of that work, the following schemes have been specified for NR Release 16 for assisting in determining a location of a UE within an area:
Downlink Time Difference of Arrival (DL-TDOA)
Uplink Time Difference of Arrival (UL-TDOA)
Downlink Angle of Departure (DL-AoD).
Uplink Angle of Arrival (UL-AoA).
Multi-cell Round Trip Time (Multi-RTT)

This work item looked to specify mechanisms for enabling both Radio Access Technology-dependent and Radio Access Technology-independent NR positioning techniques. The above-described mechanisms introduced the use of a new positioning reference signal (PRS) in the downlink and a new Sounding Reference Signal for positioning (SRS-P) in the uplink.

Release 16 further introduced UE-based positioning for downlink techniques (e.g., DL-TDOA), which means that the UE may make both the positioning measurements and the location estimate locally. In such a UE-based positioning and location mode, the location of the access points/gNBs is sent to the UE for use in the location estimation process.

Release 17 will make further changes to New Radio positioning mechanisms. One of the aims of the current Release 17 work relates to supporting high accuracy (both horizontal and vertical), low latency, network efficiency (from the point of view of, for example, scalability, reference signal overhead, etc.), and device efficiency (from the point of view of, for example, power consumption, complexity, etc.) requirements for commercial uses cases for positioning and location measurements (including general commercial use cases and Internet of Things (IoT) use cases).

3GPP Technical Specification 3GPP TS 22.261 defines a plurality of Release 17 positioning aims for horizontal and vertical positioning service levels. This is replicated below in Table 1.

TABLE 1
Performance requirements for Horizontal and Vertical positioning service levels

| | | Accuracy | | | | Coverage, environment of | | |
|---|---|---|---|---|---|---|---|---|
| | | (95% | | | | use and UE velocity | | |
| | | confidence | | | | | 5G enhanced positioning | |
| | | level) | | | | | service area | |
| Positioning | Absolute(A) | | Vertical | Positioning | Positioning | 5G | (note 2) | |
| service | or | Horizontal | Accuracy | service | service | positioning | Outdoor and | |
| level | Relative(R) | Accuracy | (note 1) | availability | latency | service area | tunnels | Indoor |
| 1 | A | 10 m | 3 m | 95% | 1 s | Indoor - up to | NA | Indoor - |
| | | | | | | 30 km/h | | up to |
| | | | | | | Outdoor | | 30 km/h |
| | | | | | | (rural and | | |
| | | | | | | urban) up to | | |
| | | | | | | 250 km/h | | |
| 2 | A | 3 m | 3 m | 99% | 1 s | Outdoor | Outdoor | Indoor - |
| | | | | | | (rural and | (dense | up to |
| | | | | | | urban) up to | urban) up to | 30 km/h |
| | | | | | | 500 km/h for | 60 km/h | |
| | | | | | | trains and up | Along roads | |
| | | | | | | to 250 km/h | up to 250 | |
| | | | | | | for other | km/h and | |
| | | | | | | vehicles | along | |
| | | | | | | | railways up to | |
| | | | | | | | 500 km/h | |
| 3 | A | 1 m | 2 m | 99% | 1 s | Outdoor | Outdoor | Indoor - |
| | | | | | | (rural and | (dense | up to |
| | | | | | | urban) up to | urban) up to | 30 km/h |
| | | | | | | 500 km/h for | 60 km/h | |
| | | | | | | trains and up | Along roads | |
| | | | | | | to 250 km/h | up to 250 | |
| | | | | | | for other | km/h and | |
| | | | | | | vehicles | along | |
| | | | | | | | railways up to | |
| | | | | | | | 500 km/h | |
| 4 | A | 1 m | 2 m | 99.9% | 15 ms | NA | NA | Indoor - |
| | | | | | | | | up to |
| | | | | | | | | 30 km/h |
| 5 | A | 0.3 m | 2 m | 99% | 1 s | Outdoor | Outdoor | Indoor - |
| | | | | | | (rural) up to | (dense | up to |
| | | | | | | 250 km/h | urban) up to | 30 km/h |
| | | | | | | | 60 km/h | |
| | | | | | | | Along roads | |
| | | | | | | | and along | |
| | | | | | | | railways up to | |
| | | | | | | | 250 km/h | |
| 6 | A | 0.3 m | 2 m | 99.9% | 10 ms | NA | Outdoor | Indoor - |
| | | | | | | | (dense | up to |
| | | | | | | | urban) up to | 30 km/h |
| | | | | | | | 60 km/h | |

| | | | | | | |
|---|---|---|---|---|---|---|
| 7 | R | 0.2 m | 0.2 m | 99% | 1 s | Indoor and outdoor (rural, urban, dense |
| | | | | | | urban) up to 30 km/h |
| | | | | | | Relative positioning is between two UEs |
| | | | | | | within 10 m of each other or between one UE |
| | | | | | | and 5G positioning nodes within 10 m of each |
| | | | | | | others (note 3) |

(note 1)
The objective for the vertical positioning requirement is to determine the floor for indoor use cases and to distinguish between superposed tracks for road and rail use cases (e.g. bridges).
(note 2)
Indoor includes location inside buildings such as offices, hospital, industrial buildings.
(note 3)
5G positioning nodes are infrastructure equipment deployed in the service area to enhance positioning capabilities (e.g. beacons deployed on the perimeter of a rendezvous area or on the side of a warehouse).

3GPP working groups have also been considering how to provide positioning services in areas where there are few local access points available, such as in rural areas/at sea. One way of addressing this is to provide positioning services via non-terrestrial networks.

non-terrestrial networks refer to networks, or segments of networks, using an airborne or spaceborne vehicle for transmission. For example, spaceborne vehicles include satellites (including Low Earth Orbiting (Low Earth Orbit) satellites, Medium Earth Orbiting (MEO) satellites, Geostationary Earth Orbiting (Geosynchronous Equatorial Orbit) satellites as well as Highly Elliptical Orbiting (HEO) satellites), while airborne vehicles: High Altitude Platforms (HAPs) encompassing Unmanned Aircraft Systems (UAS) including Lighter than Air UAS (LTA), Heavier than Air UAS (HTA), all operating in altitudes typically between 8 and 50 km, quasi-stationary.

3GPP Technical Specification 3GPP TS 22.261 also defines use cases for 5G Satellite integration, with the corresponding service requirements having been identified. This will address mobile broadband needs in unserved/underserved areas as well as public safety needs, maritime (3GPP TS 22.119 “Maritime communication services over 3GPP system”), airplane connectivity and railway communication service requirements applicable to satellite access.

Activities on NR to support non-terrestrial networks have been successively carried out over several studies. As a first example study, a channel model for non-terrestrial networks has been studied to define deployment scenarios, parameters, and key potential impacts of non-terrestrial networks on New Radio. Another example study considered key impacts identified by the first example study in order to define and evaluate solutions for them.

Another report/study into NR non-terrestrial networks concluded that such non-terrestrial networks should support at least “normative activity” (i.e. activity to develop specifications to support various scenarios) and “study activity” (i.e. activity to determine effects on coexisting other networks).

Examples of standard activity on non-terrestrial networks is expected to include transparent payload-based Low Earth Orbit and/or Geosynchronous Equatorial Orbit scenarios. The Low Earth Orbit scenario may, for example, address at least 3GPP class 3 UEs with and/or without Global Navigation Satellite System (GNSS) capability for Earth-fixed and/or moving cell scenarios. Addressing such Low Earth Orbit scenarios will also provide flexibility to support transparent payload-based High Altitude Platform scenarios. 3GPP activities in Release 17 currently assume GNSS support in UEs. However, this support may not be provided in later Releases

Addressing both Low Earth Orbit and Geosynchronous Equatorial Orbit scenarios will help enable NR to support all non-geostationary scenarios having circular orbits at altitudes greater than or equal to 400 km. Both of these scenarios assume that frequency division duplex communication is used (although it is understood that time division duplex can be used where applicable), that an Earth-fixed tracking area is used (i.e. the tracking area is considered to be fixed relative to the movement of the Earth (“Earth-fixed”), but the region covered by the coverage cells may be considered as being either Earth-fixed or Earth-moving), and that UEs for Release 17 will be configured with GNSS capabilities. However, not all UEs are expected to be configured with GNSS capabilities for later releases (such as Release 18 onwards) in order to enable coverage in forests, indoor and other places with poor GNSS reception. Further, Low Earth Orbit based non-terrestrial networks are assumed to have altitude between 300 and 1500 km. However, the propagation delay may vary with the elevation angle, with the corresponding Round Trip Time varying between 2 and 52 ms.

One of the reasons why it is important to be able to provide accurate positioning of a UE is to assist during emergencies. This is also often mandated by local laws. For example, the Federal Communication Commission's (FCC's) wireless Enhanced 911 (E911) rules seek to improve the effectiveness and reliability of wireless 911 (i.e. emergency) services by providing 911 dispatchers with additional information on wireless 911 calls. The FCC's wireless E911 rules apply to all wireless licensees, broadband Personal Communications Service (PCS) licensees, and certain Specialized Mobile Radio (SMR) licensees.

The FCC has divided its wireless E911 program into two parts-Phase I and Phase II. Under Phase I, the FCC requires carriers to, within six months of a valid request by a local Public Safety Answering Point (PSAP), provide the PSAP with the telephone number of the originator of a wireless 911 call and the location of the cell site or base station transmitting the call. Under Phase II, the FCC requires wireless carriers, within six months of a valid request by a PSAP, to begin providing information that is more precise to PSAPs, specifically, the latitude and longitude of the caller. This information should conform to FCC accuracy standards, generally to within 50 to 300 meters, depending on the type of technology used. The deployment of E911 requires the development of new technologies and upgrades to local 911 PSAPs, as well as coordination among public safety agencies, wireless carriers, technology vendors, equipment manufacturers, and local wireline carriers.

In August 2019, the FCC adopted rules requiring multi-line telephone systems (MLTS)—such as those used by hotels and campuses—to allow users to dial 911 directly i.e. without having to dial a prefix such as a “9” to reach an outside line. To facilitate building entry by first responders, MLTS also provides notification to a central location for the facility where the MLTS is installed, such as a front desk or security office, when a 911 call is made.

Also in August 2019, the FCC adopted rules to ensure that “dispatchable location” information, such as the street address, floor level, and room number of a 911 caller, is conveyed with 911 calls so that first responders can more quickly locate the caller.

As mentioned above, positioning in NR currently relies on TDOA, RTT, and/or AoA techniques. These techniques use at least three or four visible gNBs for a triangulation to be calculated. Especially in rural areas, the availability of multiple gNBs is difficult to obtain. For example, in rural areas non-terrestrial networks may be available, but a typical scenario is that the UE will see only one non-terrestrial network station, and thus have to rely on the directivity of the beam towards the non-terrestrial networks station for positioning estimates. This does not provide an accurate location estimate, but only a broad estimate. In non-terrestrial networks, the propagation delay between the UE and the gNB is much longer than for terrestrial systems (for example, for Low Earth Orbit, the propagation delay is up to 26 ms in each direction). The propagation delay is a metric indicating the length of time taken for a signal transmitted by a first entity to be received by a second entity. RTT is a measurement indicating propagation delay.

Further as mentioned above, UEs operating in accordance with Release 18 for non-terrestrial networks may not always comprise a GNSS-based mechanism for determining a position. It would therefore be advantageous to enable cellular positioning mechanisms. Providing positioning via cellular signalling mechanisms may be beneficial as GNSS positioning is a third-party mechanism to the cellular and can be spoofed more easily than the cellular system, meaning that a UE cannot be fully relied on to report a truthful location in GNSS. This can have important consequences in emergency services application.

The following proposes to use both non-terrestrial networks and ground gNBs in combination for joint positioning.

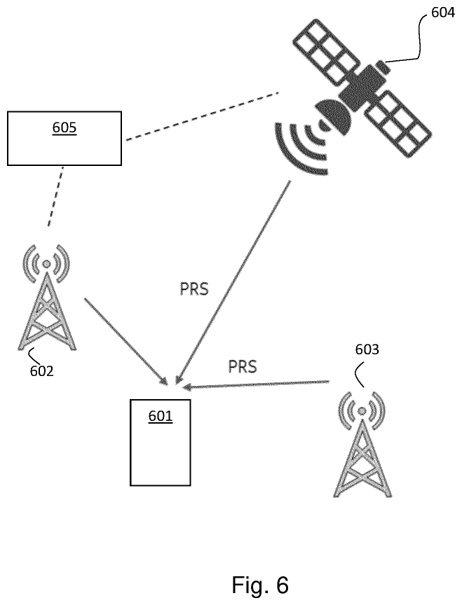

FIG. 6 illustrates a potential configuration for implementing techniques described herein.

FIG. 6 shows a UE 601 configured to receive respective positioning reference signals from each of a first terrestrial gNB 602, a second terrestrial gNB 603, and a satellite 604. The satellite 604 is configured to communicate with a Location Management Function 605. The first terrestrial gNB 602 is configured to communicate with the Location Management Function 605.

In the example of FIG. 6, the UE makes Reference Signal Time Difference (RSTD) Measurements, which are currently defined in 3GPP TS 36.214. The RSTD is defined as the relative timing difference between a reference cell and a measured cell, and is calculated by determining a smallest time difference between two subframe boundaries received from the reference cell and the measured cell.

The UE measurements are made during “inter-frequency measurement gaps”, which are configured to start at certain system frame numbers and last for a predetermined duration. The network configures inter-frequency measurement gaps for a UE when that UE is in an RRC connected state in order for the UE to receive a Positioning Reference Signal and make those RSTD measurements. These inter-frequency measurement gaps are currently configured by 3GPP TS 38.133 to have a periodicity of 20, 40, 60, 80, 120 ms, with a duration no longer than 6 ms, which corresponds to about four PRS subframes.

According to 3GPP TS 36.355, the reference cell is selected by the UE. Further, an RSTD measurement may be performed on at least one of an intra-frequency cell (i.e. when both the reference cell and the measured cell are on the same carrier frequency as the UE serving cell) and on an inter-frequency cell (i.e. when at least one of the reference cell and the measured cell are on a different carrier frequency as the UE serving cell). RSTD measurements are made to determine a location using Observed Time Difference of Arrival positioning techniques.

The RSTD measurements are to be made between PRS that are transmitted at roughly the same time in order to enable a more accurate position to be determined. However, as the transmission point for non-terrestrial networks (i.e. the satellite 604 in the present example) is much further away that the terrestrial gNBs 602, 603, a key problem for jointly estimating the position based on a combination of non-terrestrial networks and Terrestrial networks is that the measurement gap is not sufficiently large to cover the difference in the time of arrival from the signals sent from the different networks.

To address this, the window could be set to cover all the delay variation. This would for instance lead to a window of 12 ms for the Low Earth Orbit 600 km case, as the RTT can vary between 4 and 28 ms. This leads to a very large measurement gap relative to current configurations of up to 6 ms, which is not desirable.

The following proposes to address at least one of the above-mentioned problems.

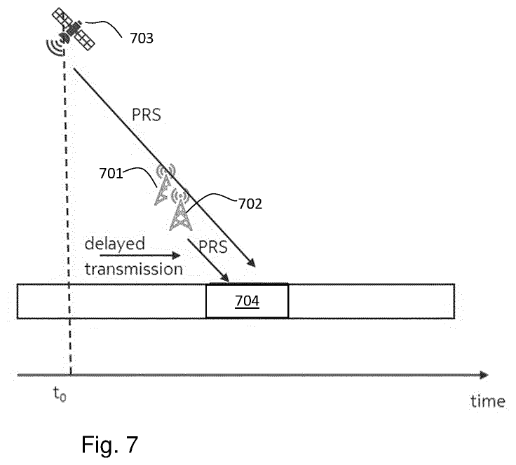

FIG. 7 illustrates an example mechanism.

FIG. 7 illustrates a first terrestrial gNB 701, a second terrestrial gNB 702 and a satellite 703, each of which are configured to transmit positioning reference signals for reception by a UE.

FIG. 7 illustrates that the PRS transmission by each of the first terrestrial gNB 701 and the second terrestrial gNB 702 are delayed relative to the PRS transmission by the satellite 703 so that all of the PRSs arrive within the configured measurement gap 704 at the UE.

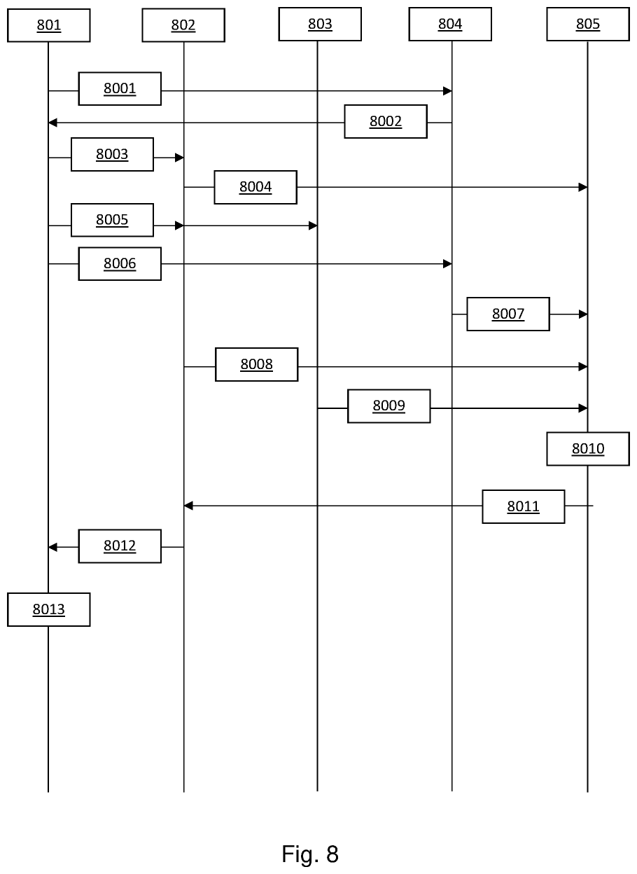

Signalling between the entities described in FIG. 7 may be as discussed below in relation to FIG. 8.

FIG. 8 illustrates signalling between a Location Management Function 801, a first terrestrial gNB 802, a second terrestrial gNB 803, a non-terrestrial gNB 804 and a UE 805. The first terrestrial gNB 802 may be a serving gNB to the UE 805, and the second terrestrial gNB 803 may be a neighbouring node to the first terrestrial gNB 802. It is understood that although the following refers to timing differences between terrestrial and non-terrestrial networks, that the same principles may be applied to any access points that have different distances to the UE 805 that cause PRS transmissions from such access points that are made simultaneously to arrive at the UE 805 at different times, the difference between such times being larger than a configured measurement gap for measuring PRSs. It is therefore understood that steps 8001 and 8002 may be performed for each access point/gNB providing a PRS to the UE 805.

At 8001, the Location Management Function 801 signals a request to the non-terrestrial gNB 804. The request may be a request for a value for a propagation delay between the non-terrestrial gNB 804 and the UE 805. For example, the request may be for a RTT for signalling between the non-terrestrial gNB 804 and the UE 805. This RTT may be determined and/or known based on the height above ground of the non-terrestrial networks network, as well as feeder link information. A feeder link is the portion of a broadcasting-satellite system that provides the connection from the earth to the broadcasting satellite. The request may be forwarded and/or handled by a control function of the non-terrestrial network to which the non-terrestrial gNB 804 belongs. It is understood that Timing Advance is an alternative mechanism for providing a propagation delay.

At 8002, the non-terrestrial gNB 804 responds to the request of 8001. The response may comprise a value for the propagation delay. For example, the response may comprise a value for the RTT associated with signalling between the non-terrestrial gNB 804 and the UE 805. The propagation delay may comprise a “worst case” delay value, corresponding to the longest time expected for transmission of the PRS signal from the non-terrestrial gNB 804 to the UE 805. The propagation delay may comprise a range of values.

At 8003, the Location Management Function 801 signals the first terrestrial gNB 802 to configure a UE measurement gap.

At 8004, in response to the signalling of 8003, the first terrestrial gNB 802 signals the UE 805 to configure a UE measurement gap for receiving PRS.

At 8005, the Location Management Function 801 signals the first and second terrestrial gNBs 802, 803 (either directly and/or indirectly) to assign measurement slot and/or gap for transmitting their respective PRSs. This assigned measurement slot and/or gap may be delayed (i.e. occur later in time) relative to the assigned measurement slot and/or gap for PRS assigned to the non-terrestrial gNB 804 in 8006.

At 8006, the Location Management Function 801 signals the non-terrestrial gNB 804 (either directly and/or indirectly) to assign measurement slot and/or gap for transmitting the non-terrestrial gNB's 804 PRS. The measurement slot and/or gap assigned at 8006 may be scheduled to occur sooner than the measurement slot and/or gap assigned at 8005 to the terrestrial gNBs. The difference in this delay may be determined in dependence on a difference between a propagation delay for the signalling between the terrestrial gNBs and the UE and a propagation delay for the signalling between the non-terrestrial gNB 804 and the UE. As the LMF may be ground-based, the assignment of 8006 may also take longer to reach the non-terrestrial networks gNB 804 relative to the terrestrial gNBs 802, 803. This difference in distance and time taken for signalling may be taken into account by performing 8006 before 8005.

Although not shown, once the assignment of 8006 has been performed, the non-terrestrial gNB 804 may provide to the location management function 801 an indication of where the non-terrestrial gNB 804 will be at the assigned time for transmitting a PRS to the UE 805 (i.e. a location for the non-terrestrial gNB 804 at the assigned time).

At 8007, the non-terrestrial gNB 804 signals a PRS to the UE 805.

At 8008 and 8009, at the delayed assignment time, the first and second terrestrial gNBs 802, 803 respectively transmit their PRS.

The arrangement of FIG. 7 may thus be effected by offsetting the PRS transmissions according to the different types of network based on a calculation of the propagation delay range of the non-terrestrial networks, using knowledge of the feeder link delay and an estimate of the range of the service link delay/propagation delay. Using examples of real-world conditions, the propagation delay range may be, for example, 12-20 ms for non-terrestrial networks. This range may be narrowed down further by additional information on the deployment. For example, when the non-terrestrial networks deployment is dense the variation may be smaller. If the network uses a smaller range in the next step and for instance use a round trip time of ˜16 ms for non-terrestrial networks, then the network may be configured to send the PRS from the terrestrial gNBs and non-terrestrial networks such that they align at the UE within the measurement gap. The Location Management function may calculate a time delay for the non-terrestrial network entities (e.g. Non-terrestrial gNB 804) based PRS transmissions to allow a single UE measurement gap to be configured at the UE.

At 8010, the UE 805 uses measurements obtained from reception of the PRSs transmitted at 8007 to 8009 to calculate a downlink Time Difference of Arrival and an Angle of Arrival. This may be calculated using known mechanisms.

At 8011, the UE 805 signals the calculated downlink Time Difference of Arrival and Angle of Arrival to the first terrestrial gNB 802.

At 8012, the first terrestrial gNB 802 signals the calculated downlink Time Difference of Arrival and Angle of Arrival received at 8011 to the location management function 801. It is more advantageous for the UE 805 to signal the calculated Time Difference of Arrival and Angle of Arrival via a terrestrial gNB rather than a non-terrestrial gNB as it uses less transmission power to reach the terrestrial gNB than the non-terrestrial gNB, saving UE power.

If the Location Management Function 801 does not receive any measurements related to the non-terrestrial networks network, the Location Management Function 801 may adjust either the propagation delay estimate and/or configure the measurement gap to have a larger size than previously. The Location Management Function 801 may continue to adjust at least one of these parameters until measurements are received that relate to both the non-terrestrial networks (e.g. Non-terrestrial gNB 804) and the terrestrial network (e.g. terrestrial gNBs 802, 803). The direction and size of the adjustment may be based on the satellite ephemeris, height, approximate location based on the terrestrial nodes which the UE can measure.

At 8013, the location management function 801 uses the calculated downlink Time Difference of Arrival and Angle of Arrival received at 8011 to calculate a position of the UE 805.

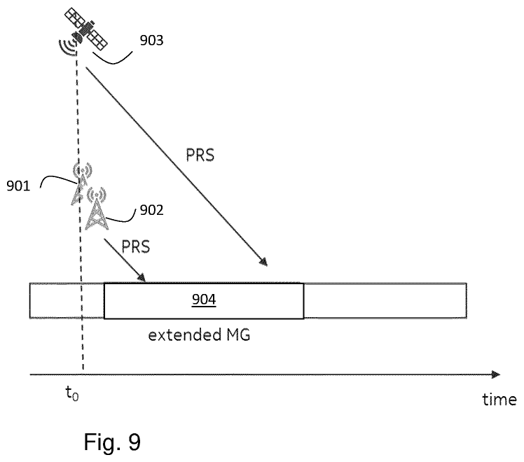

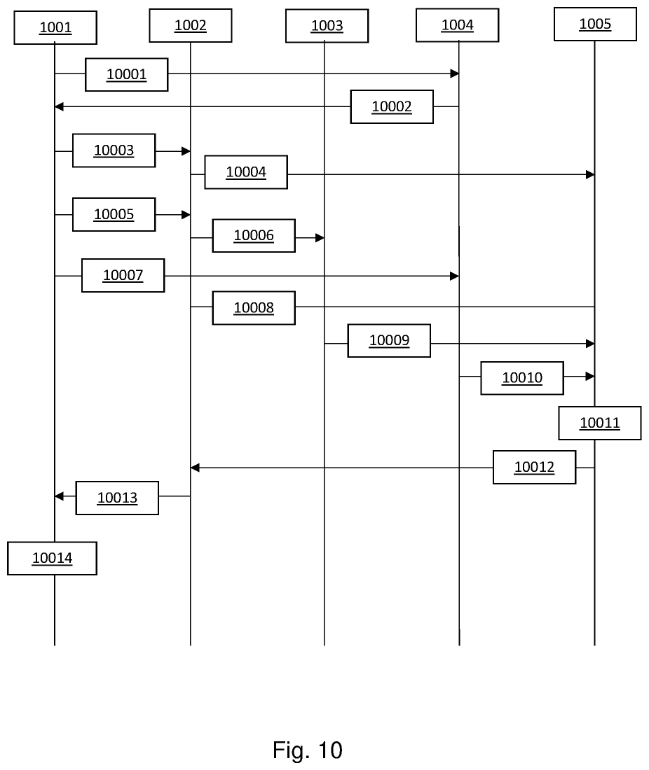

FIGS. 9 and 10 illustrate another mechanism that can be used for enabling terrestrial and non-terrestrial networks to provide positioning estimates.

FIG. 9 shows a satellite 901, a first terrestrial gNB 902 and a second terrestrial gNB 903, each of which being configured to transmit respective PRSs to a UE (not shown). The UE is configured to receive the PRSs within an extended measurement gap 904. Therefore, in the present example, the measurement gap is extended (compared to existing mechanisms) and aligned with the combined transmission from the terrestrial gNBs and the satellite 901.

FIG. 10 is a signalling diagram associated with the example of FIG. 9.

FIG. 10 shows an LMF 1001, a first (serving) terrestrial gNB 1002, a second terrestrial gNB 1003 neighbouring the first terrestrial gNB 1002, a non-terrestrial gNB 1004, and a UE 1005.

At 10001, the LMF 1001 signals the non-terrestrial gNB 1004 requesting propagation delay information relating to transmissions between the non-terrestrial gNB 1004 and the UE 1005. This propagation delay information may be, for example, round trip time information. The propagation delay information may be provided at the level of ms. The propagation delay information may be determined based on the height above ground of the non-terrestrial networks network, and/or feeder link information.

At 10002, the non-terrestrial gNB 1004 responds to the signalling of 10001 by sending the requested propagation delay information to the LMF 1001.

At 10003, the LMF 1001 signals the first terrestrial gNB 1002 to configure an extended UE measurement gap. This signalling may comprise, for example, providing an indication of the propagation delay received at 10002 and/or providing an indication of a value for the extended measurement gap.

At 10004, the first terrestrial gNB 1002 signals the UE 1005 to configure an extended UE measurement gap. The UE measurement gap is configured to be large enough to account for the propagation delay of signalling from the non-terrestrial gNB 1004 so that measurement signalling from each of the terrestrial gNBs and the non-terrestrial gNBs may be received within the same UE measurement gap.

The first terrestrial network may be made aware that the positioning data to be determined will comprise both terrestrial and non-terrestrial components (and so to configure an extended measurement gap) through signalling from at least one of the UE 1005 and/or the LMF 1001. When the UE 1005 informs the first terrestrial gNB 1002 that the positioning information comprises a non-terrestrial component, this may be signalled using, for example, Radio Resource Control signalling. When the LMF 1001 informs the first terrestrial gNB 1002 that the positioning information comprises a non-terrestrial component, this may be signalled using, for example, a new New Radio Positioning Protocol A (NRPPa) signal.

At 10005, the LMF 1001 signals the first terrestrial gNB 1002 to assign a positioning reference signal to the first terrestrial gNB 1002, and to delegate signalling of a positioning reference signal assignment for the second terrestrial gNB 1003 to the first terrestrial gNB 1002.

At 10006, the first terrestrial gNB 1002 signals the second terrestrial gNB to assign a positioning reference signal to the second terrestrial gNB 1003.

At 10007, the LMF 1001 signals a positioning reference signal assignment to the non-terrestrial gNB 1004.

At 10008, the first terrestrial gNB 1002 transmits its assigned positioning reference signal to the UE 1005.

At 10009, the second terrestrial gNB 1003 transmits its assigned positioning reference signal to the UE 1005.

At 10010, the non-terrestrial gNB 1004 transmits its assigned positioning reference signal to the UE 1005.

At 10011, the UE 1005 calculates positioning information using positioning reference signals received during its configured extended measurement gap. The positioning information may be, for example, a downlink time difference of arrival and angle of arrival for positioning reference signals received during the UE's configured extended measurement gap.

At 10012, the UE 1005 signals its calculated positioning data, or an indication thereof, to the first terrestrial gNB 1002.

When the network does not receive any positioning data resulting from the positioning reference signals assigned to the non-terrestrial networks' network (not shown), the network determines to adjust either the propagation delay estimate or set the measurement window to a larger size until the network receives positioning information relating to both the non-terrestrial networks and the terrestrial gNBs. The direction and size of the adjustment may be based on at least one of the satellite ephemeris, height, and an approximate UE location that has been determined based on the terrestrial nodes which the UE can measure.

At 10013, the first terrestrial gNB 1002 forwards the positioning data received at 10012 to the LMF 1001.

At 10014, the LMF 1001 calculates a UE position using the positioning data received at 10013.

The presently described techniques enable accurate positioning in rural areas with sparse terrestrial gNB availability by including visible non-terrestrial networks gNBs in the positioning triangulation. This includes coverage for areas vital for E911 emergency incidents. Moreover, the presently described techniques enable accurate positioning in rural areas via cellular networks only and without a need for GNSS.

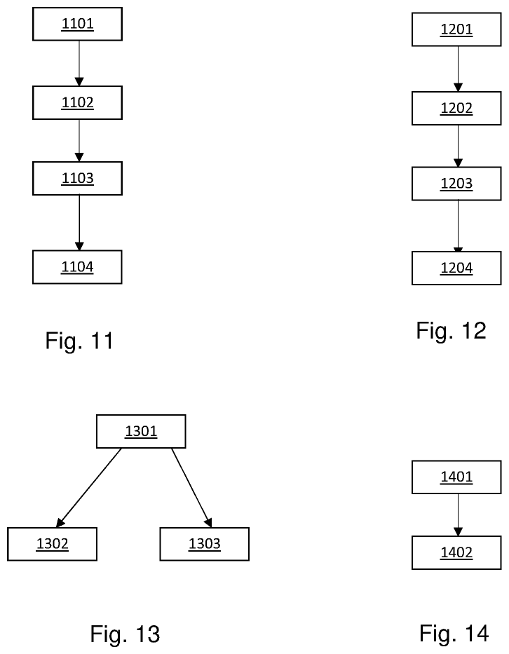

FIGS. 11 to 14 are flow charts illustrating potential operations that may be performed by apparatus described herein. These apparatus may interact with each other, as further described below.

FIG. 11 illustrates potential operations that may be performed by, for example, an apparatus for a location function. The location function may be a location management function. Depending on the specific implementation, the location function may be deployed in the core network. The location function may be deployed in an access point in a RAN part of a communication network.

At 1101, in response to determining that a plurality of access points to be configured to provide positioning signals to a user equipment comprises at least one non-terrestrial access point, the location function performs 1102.

At 1102, the location function determines, for the at least one non-terrestrial access point, a propagation delay for signalling between said non-terrestrial access point and the user equipment.

The propagation delay may be indicated in the form of a round trip time. The propagation delay may be indicated in the form of a timing advance. The propagation delay may be indicated at a ms order of granularity. This is different to some systems, where the propagation delay is indicated at a ns order of granularity.

At 1103, the location function uses the determined propagation delay to select a configuration of at least one of: a duration of a measurement gap at the user equipment in which the user equipment is to perform positioning-related measurements on positioning signals transmitted by the plurality of access points, and a transmission time of at least one positioning signal to be provided to the user equipment by at least one of the plurality of access points.

At 1104, the location function signals the selected configuration.

The selected configuration may be signalled to a serving access point of the user equipment. On receipt of the selected configuration, the serving access point may configure itself with at least part of the configuration. On receipt of the selected configuration, the serving access point may signal at least part of the configuration to a neighbouring access point that will be providing positioning signals to the user equipment. The neighbouring access point may use the received at least part of the configuration to configure itself.

The selected configuration may be signalled to the at least one non-terrestrial access point. On receipt of the selected configuration, the at least one non-terrestrial access point may configure itself with at least part of the configuration.

When a duration of the measurement gap is selected, signalling the selected configuration may comprise means for signalling the selected configuration to the user equipment either directly or indirectly. The selected configuration may be signalled directly using a non-access stratum signalling. The selected configuration may be signalled indirectly by being passed to the user equipment via an access point to the network, such as via the serving access point. The serving access point may use information provided in the selected configuration to form a configuration instruction to be signalled to the user equipment for this purpose.

The using the determined propagation delay to select a configuration may comprise: comparing the propagation delay for signalling between said non-terrestrial access point and the user equipment to a propagation delay for signalling between the user equipment and a serving access point serving the user equipment; calculating a duration of a measurement gap that would, if respective positioning signals are transmitted from the serving access point and the non-terrestrial access point at the same time, cause the respective positioning signals to be received by the user equipment within the measurement gap; and comprising an indication of the calculated duration within the selected configuration. In this context, the “measurement gap” refers to a same measurement gap i.e. a same window/duration of time.

The serving access point may be a terrestrial access point.

When a transmission time is selected, said signalling the selected configuration may comprise signalling the selected configuration to the at least one access point providing the at least one positioning signal either directly or indirectly. When the signalling is provided indirectly, this may be passed via another access point, such as via a serving access point, as described above.

The using the determined propagation delay to select a configuration may comprise: comparing the propagation delay for signalling between said non-terrestrial access point and the user equipment to a propagation delay for signalling between the user equipment and a serving access point serving the user equipment; calculating a time offset between respective transmissions of positioning signals to be transmitted from the serving access point and the non-terrestrial access point such that the respective transmissions are estimated to arrive at the user equipment within a predetermined measurement gap; and comprising an indication of the time offset within the selected configuration.

The transmission time may indicate a time for at least one terrestrial access point in the plurality of access points to transmit its positioning signal, said time being later than a time at which a non-terrestrial access point in the plurality of access points is scheduled to transmit its positioning signal.

The apparatus may receive, from an access point of the plurality of access points, an indication that measurement data obtained by the user equipment does not comprise measurement data associated with any non-terrestrial access point. This access point of the plurality of access points may be the serving access point of the user equipment. In response to this indication, the apparatus may select a new configuration by selecting at least one of: a new duration of a new measurement gap at the user equipment in which the user equipment is to perform positioning-related measurements on positioning signals transmitted by the plurality of access points, and a new transmission time of at least one positioning signal to be provided to the user equipment by at least one of the plurality of access points; and signal the selected new configuration. The new configuration may be selected such that the new transmission timing and/or the new duration is determined on at least one of a satellite ephemeris of said non-terrestrial access point, a height above ground of said non-terrestrial access point, a feeder link delay of said non-terrestrial access point, and a user equipment location determined based on the access points that the user equipment provided measurement information on.

The propagation delay may be represented by a round trip time. The propagation delay may be determined in dependence on at least one of a height above ground of said non-terrestrial access points and/or feeder links of said non-terrestrial access points.

Said means for determining the propagation delay may comprise means for signalling at least one of the non-terrestrial access points for an indication of the propagation delay, and receiving said indication of the propagation delay from the at least one non-terrestrial access point.

The determining the propagation delay for signalling between said non-terrestrial access point and the user equipment may be performed in response to both determining that a plurality of access points to be configured to provide positioning signals to a user equipment comprises at least one non-terrestrial access point and at least one terrestrial access point. In other words, steps 1102 to 1103 may be performed when it is determined that there is a mixture of terrestrial and non-terrestrial access points that will be providing positioning signals to the user equipment.

FIG. 12 is a flow chart illustrating potential operations that may be performed by a user equipment. The user equipment may interact with at least one of the apparatus of FIGS. 11, 13 and 14.

At 1201, the user equipment receives, from a serving access point, an indication that measurements on first positioning signals from a plurality of access points are to be performed within a first measurement gap having a first value.

At 1202, the user equipment may configure the first measurement gap, wherein the measurement gap is configurable to take at least the first value and a second value. In other words, the user equipment may configure itself to make measurements on positioning signals received within a first measurement gap, the first measurement gap having a duration defined by the first value.

At 1203, the user equipment determines first positioning information for the user equipment using measurements made on said first positioning signals received during the configured first measurement gap.

At 1204, the user equipment signals the first positioning information to the serving access point.

The user equipment may receive, from the serving access point, an indication that measurements on second positioning signals from the plurality of access points are to be performed within a second measurement gap having the second value. In response to this signalling, the user equipment may configure itself with a second measurement gap having the second value. In other words, the user equipment may configure itself to make measurements on positioning signals received within a second measurement gap, the second measurement gap having a duration defined by the second value. The user equipment may determine second positioning information for the user equipment using measurements made on said second positioning signals during the configured second measurement gap. The UE may signal the second positioning information to the serving access point.

FIG. 13 is a flow chart that relates to operations that may be performed by an apparatus for an access point configured to serve a user equipment. This apparatus may interact with at least one of the apparatus of FIGS. 11, 12 and 14.

At 1301, the access point receives, from a location function, a configuration of at least one of: a duration of a measurement gap at the user equipment in which the user equipment is to perform positioning-related measurements on positioning signals transmitted by the plurality of access points, and a transmission time of at least one positioning signal to be provided to the user equipment by at least one of the plurality of access points. The location function may be the location function of FIG. 11.

When the duration is indicated in the configuration, the access point performs step 1302, which comprises signalling the duration to the user equipment.

When the transmission time is indicated in the configuration, the access point performs step 1303, which comprises signalling a positioning signal to the user equipment at the transmission time.

The access point may receive, from the location function, a new configuration of at least one of: a new duration of a measurement gap at the user equipment in which the user equipment is to perform positioning-related measurements on positioning signals transmitted by the plurality of access points, and a new transmission time of at least one positioning signal to be provided to the user equipment by at least one of the plurality of access points. In this case, when the new duration is indicated in the configuration, signalling the new duration to the user equipment. Further, when the new transmission time is indicated in the configuration, signalling a positioning signal to the user equipment at the new transmission time. The new configuration may be received after the access point has forwarded positioning information to the location function that has been received from the user equipment. This forwarded positioning information may not comprise positioning information determined using positioning signals received from a non-terrestrial access point. That the forwarded positioning information does not comprise positioning information determined using positioning signals received from a non-terrestrial access point may be explicitly indicated in the forwarded message, or implicitly indicated by a lack of the non-terrestrial access point being identified.

The serving access point may be a terrestrial access point.

The serving access point may be a non-terrestrial access point.

FIG. 14 is a flow chart illustrating potential operations that may be performed by, for example, an apparatus for a non-terrestrial access point. The non-terrestrial access point of FIG. 14 may interact with at least one of the apparatus of FIGS. 11 to 13.

At 1401, the non-terrestrial access point receives, from a location function, a request for an indication of a propagation delay for signalling between said non-terrestrial access point and a user equipment.

At 1402, the non-terrestrial access point provides, to the location function, the requested indication.

The propagation delay may be as discussed above. For example, represented by a round trip time. The propagation delay may be determined in dependence on at least one of a height above ground of said non-terrestrial access point and/or feeder links of said non-terrestrial access point.

It is understood that although the above refers to “Positioning Reference Signals” in various examples, that this is not limiting, and that the presently described techniques may be applied to any type of signal that may be used by the UE to make location-related measurements.

Further, the location management function referred to above may be located/deployed in the core network (e.g. as a standalone entity), or as a local management component inside a radio access network (RAN), depending on the specific location management function being considered.

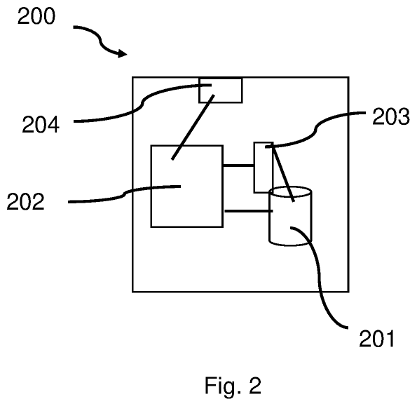

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR etc. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example the control apparatus 200 or processor 201 can be configured to execute an appropriate software code to provide the control functions.

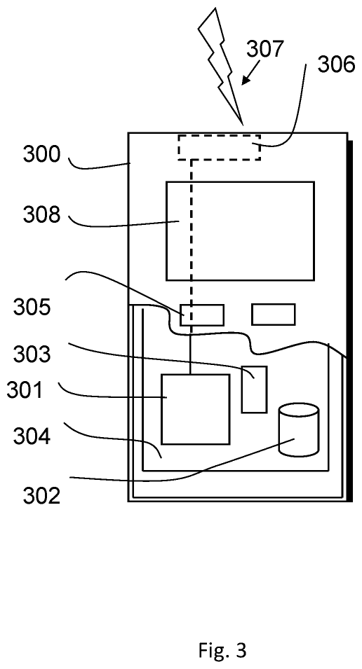

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. In the present teachings the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the wireless device.

A wireless device is typically provided with at least one data processing entity 301, at least one memory 302 and other possible components 303 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 704. The user may control the operation of the wireless device by means of a suitable user interface such as key pad 305, voice commands, touch sensitive screen or pad, combinations thereof or the like. A display 308, a speaker and a microphone can be also provided. Furthermore, a wireless communication device may comprise appropriate connectors (either wired or wireless) to other devices and/or for connecting external accessories, for example hands-free equipment, thereto.

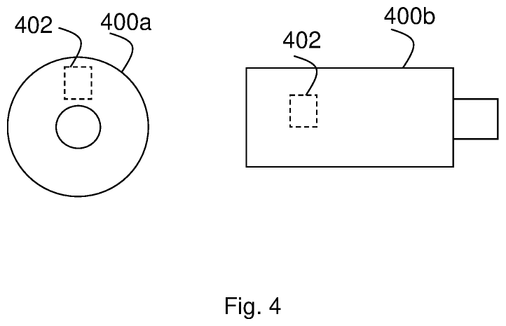

FIG. 4 shows a schematic representation of non-volatile memory media 400a (e.g. computer disc (CD) or digital versatile disc (DVD)) and 400b (e.g. universal serial bus (USB) memory stick) storing instructions and/or parameters 402 which when executed by a processor allow the processor to perform one or more of the steps of the methods of FIG. 11 and/or FIG. 12 and/or FIG. 13 and/or FIG. 14.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIG. 11 and/or FIG. 12 and/or FIG. 13 and/or FIG. 14, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (AStudy ItemC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory (ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

In the above, different examples are described using, as an example of an access architecture to which the presently described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

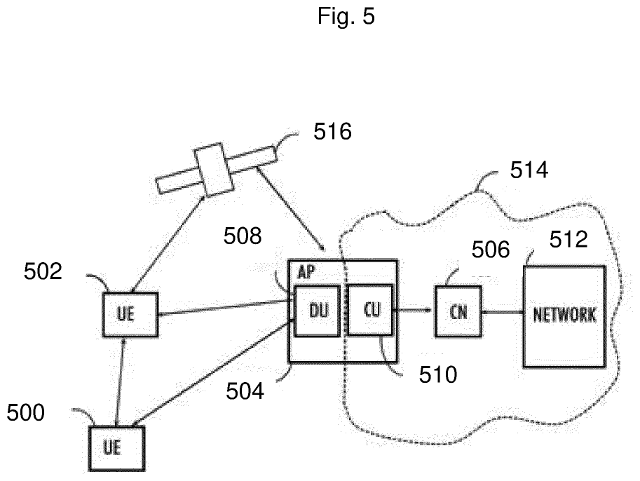

FIG. 5 depicts examples of simplified system architectures only showing some elements and functional entities, all being logical units, whose implementation may differ from what is shown. The connections shown in FIG. 5 are logical connections; the actual physical connections may be different. It is apparent to a person skilled in the art that the system typically comprises also other functions and structures than those shown in FIG. 5.

The examples are not, however, restricted to the system given as an example but a person skilled in the art may apply the solution to other communication systems provided with necessary properties.

The example of FIG. 5 shows a part of an exemplifying radio access network. For example, the radio access network may support sidelink communications described below in more detail.

FIG. 5 shows devices 500 and 502. The devices 500 and 502 are configured to be in a wireless connection on one or more communication channels with a node 504. The node 504 is further connected to a core network 506. In one example, the node 504 may be an access node such as (e/g) NodeB serving devices in a cell. In one example, the node 504 may be a non-3GPP access node. The physical link from a device to a (e/g) NodeB is called uplink or reverse link and the physical link from the (e/g) NodeB to the device is called downlink or forward link. It should be appreciated that (e/g) NodeBs or their functionalities may be implemented by using any node, host, server or access point etc. entity suitable for such a usage.

A communications system typically comprises more than one (e/g) NodeB in which case the (e/g) NodeBs may also be configured to communicate with one another over links, wired or wireless, designed for the purpose. These links may be used for signalling purposes. The (e/g) NodeB is a computing device configured to control the radio resources of communication system it is coupled to. The NodeB may also be referred to as a base station, an access point or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to devices. The antenna unit may comprise a plurality of antennas or antenna elements. The (e/g) NodeB is further connected to the core network 506 (CN or next generation core NGC). Depending on the deployed technology, the (e/g) NodeB is connected to a serving and packet data network gateway (S-GW+P-GW) or user plane function (UPF), for routing and forwarding user data packets and for providing connectivity of devices to one or more external packet data networks, and to a mobile management entity (MME) or access mobility management function (AMF), for controlling access and mobility of the devices.

Examples of a device are a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or, in some examples, a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 5) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G is expected to have multiple radio interfaces, e.g. below 6 GHz or above 24 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, 6 or above 24 GHz-cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 512, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 5 by “cloud” 514). The communication system may also comprise a central control entity, or a like, providing facilities for networks of different operators to cooperate for example in spectrum sharing.

The technology of Edge cloud may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 508) and non-real time functions being carried out in a centralized manner (in a centralized unit, CU 510).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g) NodeBs, the device may have an access to a plurality of radio cells and the system may comprise also other apparatuses, such as physical layer relay nodes or other network elements, etc. At least one of the (e/g) NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto-or picocells. The (e/g) NodeBs of FIG. 5 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

For fulfilling the need for improving the deployment and performance of communication systems, the concept of “plug-and-play” (e/g) NodeBs has been introduced. Typically, a network which is able to use “plug-and-play” (e/g) Node Bs, includes, in addition to Home (e/g) NodeBs (H (e/g) nodeBs), a home node B gateway, or HNB-GW (not shown in FIG. 5). A HNB Gateway (HNB-GW), which is typically installed within an operator's network may aggregate traffic from a large number of HNBs back to a core network.

1. An apparatus for a location function, comprising at least one processor and at least one memory comprising code that, when executed by the at least one processor, causes the apparatus to:
in response to determining that a plurality of access points to be configured to provide positioning signals to a user equipment comprises at least one non-terrestrial access point:
determine, for the at least one non-terrestrial access point, a propagation delay for signalling between said non-terrestrial access point and the user equipment;
use the determined propagation delay to select a configuration of at least one of: a duration of a measurement gap at the user equipment in which the user equipment is to perform positioning-related measurements on positioning signals transmitted by the plurality of access points, and a transmission time of at least one positioning signal to be provided to the user equipment by at least one of the plurality of access points; and
signal the selected configuration.

2. The apparatus as claimed in claim 1, wherein a duration of the measurement gap is selected, the apparatus being further caused to signal the selected configuration to the user equipment either directly or indirectly.

3. The apparatus as claimed in claim 2, wherein the means for using apparatus is further caused to:
compare the propagation delay for signalling between said non-terrestrial access point and the user equipment to a propagation delay for signalling between the user equipment and a serving access point serving the user equipment;
calculate a duration of a measurement gap that would, if respective positioning signals are transmitted from the serving access point and the non-terrestrial access point at the same time, cause the respective positioning signals to be received by the user equipment within the measurement gap; and
comprise an indication of the calculated duration within the selected configuration.

4. The apparatus as claimed in claim 1, wherein a transmission time is selected, wherein the apparatus is further caused to signal the selected configuration to the at least one access point providing the at least one positioning signal either directly or indirectly.

5. The apparatus as claimed in claim 4, wherein the apparatus is further caused to:
compare the propagation delay for signalling between said non-terrestrial access point and the user equipment to a propagation delay for signalling between the user equipment and a serving access point serving the user equipment;
calculate a time offset between respective transmissions of positioning signals to be transmitted from the serving access point and the non-terrestrial access point such that the respective transmissions are estimated to arrive at the user equipment within a predetermined measurement gap; and
comprise an indication of the time offset within the selected configuration.

6. The apparatus as claimed in claim 1, wherein the transmission time indicates a time for at least one terrestrial access point in the plurality of access points to transmit its positioning signal, said time being later than a time at which a non-terrestrial access point in the plurality of access points is scheduled to transmit its positioning signal.

7. The apparatus as claimed in claim 1, wherein the apparatus is further caused to:
receive, from an access point of the plurality of access points, an indication that measurement data obtained by the user equipment does not comprise measurement data associated with any non-terrestrial access point;
select a new configuration by selecting at least one of: a new duration of a new measurement gap at the user equipment in which the user equipment is to perform positioning-related measurements on positioning signals transmitted by the plurality of access points, and a new transmission time of at least one positioning signal to be provided to the user equipment by at least one of the plurality of access points; and
signal the selected new configuration.

8. The apparatus according to claim 7, wherein the new configuration is selected such that the new transmission timing and/or the new duration is determined on at least one of a satellite ephemeris of said non-terrestrial access point, a height above ground of said non-terrestrial access point, a feeder link delay of said non-terrestrial access point, and a user equipment location determined based on the access points that the user equipment provided measurement information on.

9. The apparatus according to claim 1, wherein the propagation delay is represented by a round trip time, and/or wherein the propagation delay is determined in dependence on at least one of a height above ground of said non-terrestrial access points and/or feeder links of said non-terrestrial access points.

10. The apparatus according to claim 1, wherein the apparatus is further caused to signal at least one of the non-terrestrial access points for an indication of the propagation delay, and receive said indication of the propagation delay from the at least one non-terrestrial access point.

11. The apparatus according to claim 1, wherein the determining the propagation delay for signalling between said non-terrestrial access point and the user equipment is performed in response to both determining that a plurality of access points to be configured to provide positioning signals to a user equipment comprises at least one non-terrestrial access point and at least one terrestrial access point.

12. An apparatus for a user equipment, the apparatus comprising at least one processor; and at least one memory comprising code that, when executed by the at least one processor, causes the apparatus to:
receive, from a serving access point, an indication that measurements on first positioning signals from a plurality of access points are to be performed within a first measurement gap having a first value;
configure the first measurement gap, wherein the measurement gap is configurable to take at least the first value and a second value;
determine first positioning information for the user equipment using measurements made on said first positioning signals during the configured first measurement gap; and
signal the first positioning information to the serving access point.

13. The apparatus as claimed in claim 12, being further caused to:
receive, from the serving access point, an indication that measurements on second positioning signals from the plurality of access points are to be performed within a second measurement gap having the second value;
configure the second measurement gap to have the second value;
determine second positioning information for the user equipment using measurements made on said second positioning signals during the configured second measurement gap; and
signalling the second positioning information to the serving access point.

14. An apparatus for an access point configured to serve a user equipment, the apparatus comprising at least one processor; and at least one memory comprising code that, when executed by the at least one processor, causes the apparatus to:
receive, from a location function, a configuration of at least one of: a duration of a measurement gap at the user equipment in which the user equipment is to perform positioning-related measurements on positioning signals transmitted by the plurality of access points, and a transmission time of at least one positioning signal to be provided to the user equipment by at least one of the plurality of access points; and
when the duration is indicated in the configuration, signal the duration to the user equipment; and
when the transmission time is indicated in the configuration, signal a positioning signal to the user equipment at the transmission time.

15. The apparatus according to claim 14, being further caused to:
receive, from the location function, a new configuration of at least one of: a new duration of a measurement gap at the user equipment in which the user equipment is to perform positioning-related measurements on positioning signals transmitted by the plurality of access points, and a new transmission time of at least one positioning signal to be provided to the user equipment by at least one of the plurality of access points; and
when the new duration is indicated in the configuration, signal the new duration to the user equipment; and
when the new transmission time is indicated in the configuration, signal a positioning signal to the user equipment at the new transmission time.

16-25. (canceled)
